(19) United States
(12) Patent Application Publication
(10) Pub. No.: US 2004/0199423 A1
(43) Pub. Date: Oct. 7, 2004

(54) Integrated event management system, method, and program

(76) Inventors: Michelle LaBrosse, Stateline, NV (US); Rudi Mallant, Monroe, WA (US)

Correspondence Address: HOFFMAN WARNICK & D'ALESSANDRO, LLC, 3 E-COMM SQUARE, ALBANY, NY, 12207

(21) Appl. No.: 10/815,296

(22) Filed: Apr. 1, 2004

Related U.S. Application Data
(60) Provisional application No. 60/459,402, filed on Apr. 1, 2003.

(51) Int. Cl. G06F 17/60

(52) U.S. Cl. 705/14

(57) ABSTRACT

A system, method and program product that integrate event management and customer relationship management. Customer information and event information are used to promote events and solicit feedback from event attendees. Additional functionality can also be included, such as accounting and transaction processing to provide additional automation for the event provider.

### REFERENCE TO PRIOR APPLICATION

The current application claims the benefit of co-pending U.S. Provisional Application No. 60/459,402, filed on Apr. 01, 2003, which is hereby incorporated herein by reference.

### BACKGROUND OF THE INVENTION

1. Technical Field

The invention generally relates to automated event registration and customer relationship management. In particular, the invention provides a system, method, and program product in which the customer relationship and event registration aspects of event management are integrated.

2. Background Art

Event registration and customer relationship management are increasingly being performed over the Internet. For example, a user can fill out information on a web site to register for an event. Similarly, a user can enter an email address and/or other identifying information to receive information on upcoming events, details of events, etc. However, no existing approach provides a solution that integrates the two functions while providing a complete solution for event providers. For example, event providers frequently seek feedback from attendees of the event so that the success of the event can be gauged. As a result, there exists a need for a system, method, and program product that integrate customer relationship management functions with event registration.

### SUMMARY OF THE INVENTION

The invention provides an event management system, method, and program product that integrate acquiring, maintaining and exploiting customer relationships with scheduling, promoting, and registering customers for events. For example, a training company can go to a third party web site and submit a form for an upcoming training event (e.g., exam prep course, bar review, etc.) that they are hosting. A link is added to the training company's web site that allows customers to register for the training event at the third party's web site. The training company manages (e.g., provides reports, exam scoring, changes event details, etc.) each training event that the training company holds through the third party web site. Information on the training event (e.g., location, hotel information, cost, instructor, etc.) is automatically posted at the third party web site.

The invention also includes a customer relationship system (CRS) that manages a customer database that includes leads, subscribing customers, etc. for each training company. A customer may be added to the database, for example, by visiting the training company's web site and providing identifying information to receive a free item. The CRS notifies customers selected from the customer database of an upcoming event. The CRS also allows the training company to perform online marketing via email. A customer can register for the event by going to the third party web site. Payment by the customer can be made at the web site, and the customer can receive notices about the training event and/or payment by email. A customer that has registered for a training event can also visit the third party web site to manage his/her own account (e.g., change training events, view others that have registered, subscribe/unsubscribe to promotions, change information, etc.).

A first aspect of the invention provides a system for integrating event management, the system comprising: a customer relationship system for managing customer information for customers; an event management system for managing event information for events; and a marketing system for contacting customers, the marketing system including: a promotion system for informing customers of an event; and a feedback system for obtaining feedback from customers that attended the event.

A second aspect of the invention provides a method of integrating event management over the Internet, the method comprising: defining an event of an event provider at a third party web site; adding a link from an event provider web site to an event registration web page at the third party web site; registering a customer for the event using the event registration web page; and obtaining feedback on the event from a customer that attended the event.

A third aspect of the invention provides a computer program product comprising a computer useable medium having computer readable program code embodied therein for integrating event management, the program product comprising: program code configured to manage customer information for event providers; program code configured to manage event information for the event providers; and program code configured to market an event of an event provider to customers of the event provider, wherein the program code configured to market an event includes: program code configured to promote the event to customers using email; and program code configured to obtain feedback on the event from a customer that attended the event.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a block diagram of an illustrative event management system according to one embodiment of the invention;

FIG. 2 shows a more detailed process flow diagram for one embodiment of the various systems shown in FIG. 1;

FIG. 3 shows illustrative security levels according to one embodiment of the invention;

FIG. 4 shows illustrative method steps performed from an event provider's perspective according to one embodiment of the invention; and

FIG. 5 shows illustrative method steps performed from an event attendee's perspective according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The invention provides an event management system, method, and program product that integrate acquiring, maintaining and exploiting customer relationships with scheduling, promoting, and registering customers for events. For example, a training company can go to a third party web site and submit a form for an upcoming training event (e.g., exam prep course, bar review, etc.) that it is hosting. A link is added to the training company's web site that allows customers to register for the training event at the third party's web site. The training company manages (e.g., provides reports, exam scoring, changes event details, etc.) each training event that the training company holds through the third party web site. Information on the training event (e.g., location, hotel information, cost, instructor, etc.) is automatically posted at the third party web site.

The invention also includes a customer relationship system (CRS) that manages a customer database that includes leads, subscribing customers, etc. for each training company. A customer may be added to the database, for example, by visiting the training company's web site and providing identifying information to receive a free item. The CRS notifies customers selected from the customer database of an upcoming event. The CRS also allows the training company to perform online marketing via email. A customer can register for the event by going to the third party web site. Payment by the customer can be made at the web site, and the customer can receive notices about the training event and/or payment by email. A customer that has registered for a training event can also visit the third party web site to manage his/her own account (e.g., change training events, view others that have registered, subscribe/unsubscribe to promotions, change information, etc.).

It is understood that the term “event provider” refers to an individual/company (including an employee of a company) that schedules an event for others to attend. Typical events include seminars, courses, entertainment events, etc. Further, events can include any type of service such as a movie showing, an airplane flight, a shuttle service, etc. It is also understood that the term “customer” includes leads (e.g., potential customers), previous customers, individuals that have subscribed to a correspondence list, etc., the term “registrant” refers to a customer that has registered to attend a future event, the term “attendee” refers to a customer that has attended an event provided by the event provider, and the term “user” refers to an individual accessing the system that has not been identified, and may be a customer, an event provider, etc.

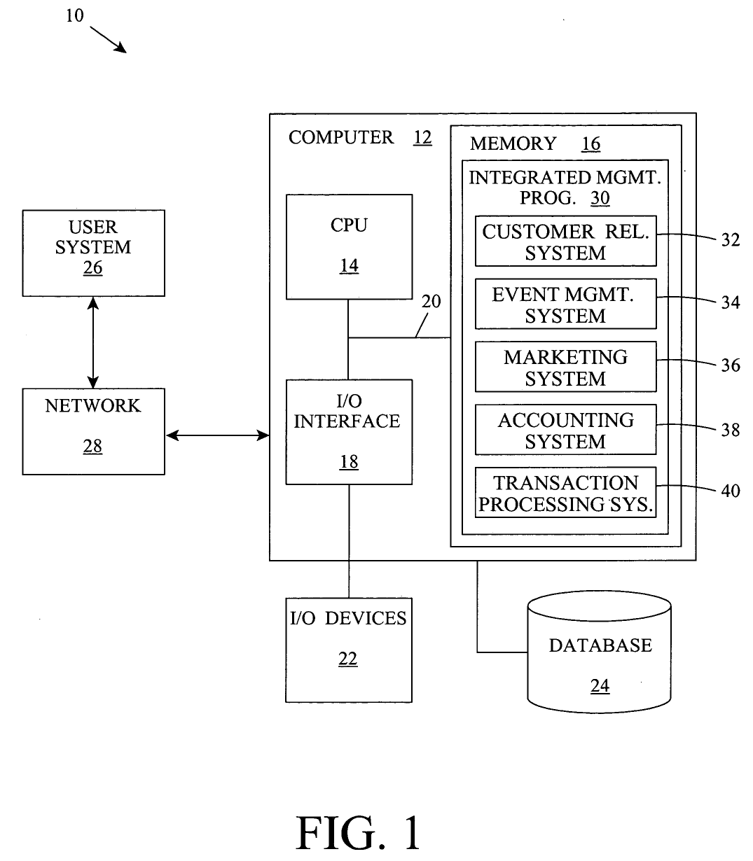

Turning to the Figures, FIG. 1 shows an illustrative integrated event management system 10 according to one aspect of the invention. System 10 includes a computer system 12 that generally comprises a central processing unit (CPU) 14, memory 16, input/output (I/O) interface 18, bus 20, I/O devices 22, and database 24. User system 26 is shown in communication with computer system 12 via a network 28 (e.g., LAN, WAN, Internet, etc.). It is understood that computer system 12 and user system 26 comprise any type of device capable of accepting input, providing output, and communicating with another device. To this extent, computer system 12 represents any type of computerized system for providing access to a web site (e.g., a web server), and user system 26 represents any type of computerized system that can be used to access the world wide web (e.g., a mobile phone, a handheld computer, a personal digital assistant, a portable (laptop) computer, a desktop computer, a workstation, a mainframe computer etc.).

Communications between user system 26, computer system 12, and/or network 28 can occur via one or more direct hardwired connections (e.g., serial port), or via an addressable connection in a client-server (or server-server) environment which may utilize any combination of wireline and/or wireless transmission methods. In the case of the latter, the server and client may be connected via the Internet, a wide area network (WAN), a local area network (LAN), a virtual private network (VPN), or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Computer system 12 can comprise any general purpose or specific-use system utilizing standard operating system software, which is designed to drive the operation of the particular hardware and which is compatible with other system components and I/O controllers. CPU 14 may comprise a single processing unit, multiple processing units capable of parallel operation, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interface 18 may comprise any system for exchanging information with one or more I/O devices 22, including an I/O port (serial, parallel, ethernet, keyboard, mouse, etc.), an universal serial bus (USB) port, expansion bus, integrated drive electronics (IDE), etc. I/O devices 22 may comprise any known type of input/output device capable of communicating with I/O interface 18 with or without additional devices (e.g., expansion cards), including a network system, a modem, speakers, a monitor (cathode-ray tube (CRT), liquid-crystal display (LCD), etc.), hand-held device, keyboard, mouse, voice recognition system, speech output system, scanner, printer, facsimile, pager, storage devices, etc. Bus 20 provides a communication link between each of the components in computer system 12 and likewise may comprise any known type of transmission link, including electrical, optical, wireless, etc. In addition, although not shown, additional components, such as cache memory, communication systems, system software, etc., may be incorporated into computer system 12. It is understood that although not shown, user system 26 typically contains components (e.g., CPU, memory, etc.) similar to computer system 12. Such components have not been separately depicted and described for brevity purposes.

Database 24 may provide storage for information necessary to carry out the present invention as described in more detail below. As such, database 24 may include one or more storage devices, such as a magnetic disk drive or an optical disk drive. Further, database 24 can include data distributed across, for example, a LAN, WAN or a storage area network (SAN) (not shown). Database 24 may also be configured in such a way that one of ordinary skill in the art may interpret it to include one or more storage devices.

Integrated management program 30 is shown stored in memory 16 as computer program code. Integrated management program 30 includes a customer relationship system 32, an event management system 34, a marketing system 36, an accounting system 38, and a transaction processing system 40. The functionality of each of the systems shown in integrated management program 30 will be described below. It is understood that the systems shown and described herein are only an illustrative embodiment. As a result, various alternative embodiments are possible, including combining some or all of the functionality provided by multiple systems, adding additional systems, removing unnecessary systems, and/or storing the various systems on two or more computers 12.

As discussed previously, the invention integrates both event management and customer relationship management into a complete solution. From an event provider's perspective, the entire process of event scheduling, marketing, registration, and post-event analysis can be performed using the invention. From a customer's perspective, the entire process of learning of, registering for, planning to attend, paying for, and providing feedback on an event can be performed using the invention. As a result, the invention provides an integrated event management system, method, and program product.

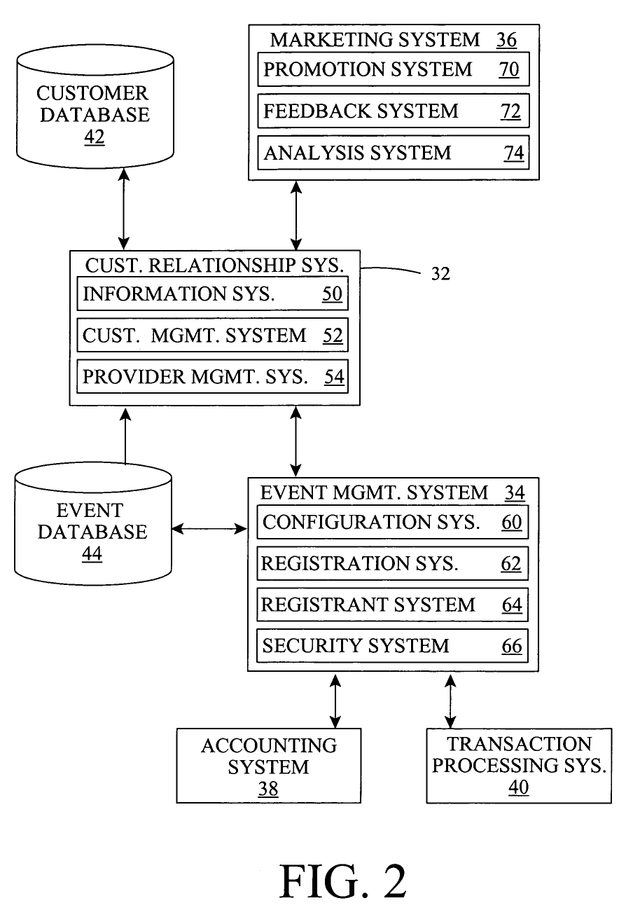

FIG. 2 shows a more detailed process flow diagram for one embodiment of the various systems shown in FIG. 1. Customer relationship system 32 manages customer information that is stored in customer database 42. Customer information can include any combination of identifying information for a customer including a name, telephone number, fax number, address, email address, company information, subscription status, etc. Customer relationship system 32 allows both customers and event providers to manage the customer information. To this end, customer relationship system 32 is shown including an information system 50, a customer management system 52, and a provider management system 54. Further, customer relationship system 32 can read event information stored in event database 44. This allows customer information to be displayed in conjunction with event information for events that the customer(s) have attended and/or are registered to attend. Alternatively, customer relationship system 32 can communicate with event management system 34 to obtain event information. Prior to a user being allowed to view and/or modify data using customer relationship system 32, customer relationship system 32 may require a login and password to identify the user. Customer relationship system 32 can then limit access to certain data/functionality based on the identification of the user. For example, a customer may be only allowed to view and/or modify his/her own customer information, while an event provider may be allowed to view and/or modify customer information for multiple customers. Additional security levels can be provided and are discussed in more detail below.

Information system 50 generates web pages, electronic files, etc. for displaying customer information and/or event information. For example, information system 50 can generate a listing of upcoming events for an event provider. Further, an event provider may wish to view a list of customers attending a particular event, or a customer may wish to view his/her own customer and event information. Information system 50 reads the necessary information from customer database 42 and/or event database 44 and generates the desired output in the correct format. To this end, information system 50 may use one or more of a plurality of forms that place data in a predefined format. Information system 50 can read the data and populate the form according to the data that was read.

When the data is provided electronically, such as on a web page, information system 50 can include links that allow the user (e.g., event provider or customer) to obtain additional information and/or edit the data. Based on the link selected and identification of the user, control may be passed to customer management system 52, provider management system 54, or event management system 34. Customer management system 52 allows a customer to manage (e.g., view, add, modify, delete) his/her own customer information. For example, a customer can use customer relationship system 32 to set his/her subscription status. Provider management system 54 allows an event provider to manage (e.g., view, add, modify, delete) customers and customer information for the customers of the event provider. For example, an event provider may wish to add a new group of contacts that were recently purchased from a third party, or an existing customer may telephone an event provider to request a change to his/her customer information.

Event management system 34 manages event information for events that are stored in event database 44. Event information can include a title, a description (summary), date(s), a location, time(s), instructor(s), a cost, a maximum number of attendees, current list of registrants, etc. Additional information that is ancillary to the event, such as available accommodations, and travel options can also be included. Further, the event information can include various settings that can be customized by an event provider to alter the information and/or the format for the information that is displayed to users.

Event management system includes a configuration system 60, a registration system 62, a registrant system 64, and a security system 66. Configuration system 60 allows an event provider to manage its events, e.g., the event provider can manage events and attributes of events. Registration system 62 can display one or more upcoming events to a customer, and register/unregister the customer for an event. Registrant system 64 provides customers that have registered for an event (e.g., registrants) additional data on the event, request/obtain materials for the event, etc. Security system 66 limits a user's access to one or more of the systems and/or functions provided by the systems included in event management system 34.

Event management system 34 communicates with accounting system 38 and transaction processing system 40 to implement additional functionality for events. Accounting system 38 manages the accounting information for each event. For example, each time a registrant is added to an event, the registrant name, date of the event, and cost of the event can be forwarded to accounting system 38. Similarly, should a registrant unregister from the event, this information can be forwarded to accounting system 38. Once the event is held, and all registrants are confirmed, the proper amount can be added to the event provider's balance sheet. Similarly, the expenses for each event can be properly deducted. Accounting system 38 can also manage additional data such as volume discounts, promotional offers, etc. that may reduce the amount paid by a registrant to attend the event. Transaction processing system 40 processes electronic payment for an event. This can comprise, for example, debiting a corporate account, verifying a credit card transaction, performing an electronic funds transfer, etc.

Marketing system 36 interacts with customers based on customer information and event information, and includes a promotion system 70, a feedback system 72, and an analysis system 74. Promotion system 70 promotes one or more upcoming events offered by an event provider. For example, the event provider can define an event using event management system 34, and then access promotion system 70 to promote the event. Promotion system 70 can promote an event using any known communications format, including direct mail, email, automated or semi-automated telephone calls, etc. The event provider defines the promotion by selecting the format for the promotion, the event, and a group of customers that will receive the promotion. The event provider may select the format of the promotion from one or more forms or define the entire promotion. Once complete, the event provider can select a date/time to send the promotion to the customers, or request that it be sent immediately. Still further, promotion system 70 can generate promotions that are not targeted to a specified group of customers such as magazine adds, electronic adds, etc.

Feedback system 72 solicits feedback from attendees of an event. Feedback system 72 provides functions similar to promotion system 70 to request feedback from event attendees. For example, an event provider can use feedback system 72 to send a questionnaire about the event to all attendees via mail or email. Alternatively, feedback system 72 can generate a list of phone numbers and questions that an employee of the event provider then asks attendees during a telephone call. Prior to sending correspondence to a customer, promotion system 70 and/or feedback system 72 can check the email/phone numbers against “do not call” or “do not email” registries to ensure that the customer has not expressed a desire not to be contacted in such a manner. When the correspondence is sent via email, the email can include a link that allows the customer to be removed from the list and not receive any additional email correspondence (e.g., unsubscribe from the list). Further, promotion system 70 and feedback system 72 can purge the client information of invalid addresses, email addresses, telephone numbers, etc. Analysis system 74 provides analysis of an event. For example, analysis system 74 can generate reports that allow sales and marketing individuals to determine the effectiveness of marketing, the quality of a particular event, etc., which can be incorporated when planning future events.

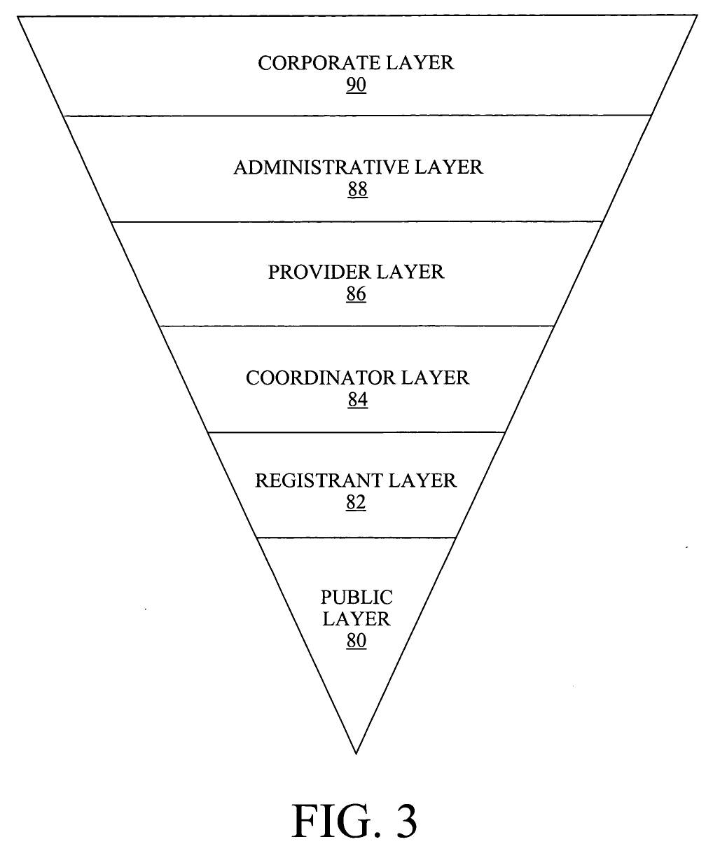

As discussed briefly above, customer relationship system 32 can incorporate security measures such as a user name and password to limit access to the customer information and/or the functions provided by customer relationship system 32. Similarly, event management system 34 includes a security system 66 that provides these limitations. FIG. 3 shows illustrative security levels that can be implemented for information provided over the Internet by customer relationship system 32 and/or event management system 34. The security levels are shown having a triangular shape, with the unsecured level having the smallest width and the most secure level having the widest width.

In this embodiment, the initial security level is public layer 80. Public layer 80 allows users to obtain anonymous access to the web site to view information on events. The remaining security levels require that a user be identified. When a user registers for an event, the user can be provided with a user name and password so that the user can be identified as a registrant. Registrants of an event obtain access to registrant layer 82. Registrant layer 82 allows the registrant to manage his/her customer information, view additional information on the event, communicate with the coordinator (e.g., instructor), obtain/request material for the event, etc. Coordinator layer 84 provides event coordinators with the ability to edit details on the event, contact all registrants, etc. Provider layer 86 allows an event planner for the event provider to add new events, remove scheduled events, modify event data, etc. Administrative layer 88 allows administrators for the event provider to view overall data for the events such as sales, marketing, accounting, etc. Corporate layer 90 allows unlimited access to the customer relationship system 32 and/or event management system 34 to perform maintenance on the data, make modifications to the basic functionality of the system, etc. It is understood that users that have access to a more secure security level can be able to use some or all of the functionality available at a lesser security level.

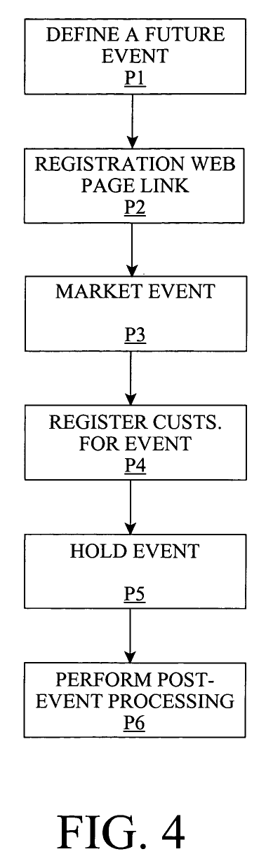

FIG. 4 shows illustrative method steps performed from an event provider's perspective according to one embodiment of the invention, and is discussed with reference to FIG. 2. In step P1, the event provider defines an event using configuration system 60. In order to create an event, security system 66 can require a user to provide a user name and password that has a security level that allows the user to create events, e.g., provider layer 86 of FIG. 3.

In step P2, configuration system 60 generates a link for a web page that allows users to register for the event. The event provider can add the link to it's web site so that a customer can register for the event by going through the provider's web site. When the link is selected by a customer, the event provider web site can display the registration web page in a new instance of the browser, frame the registration web page, or direct the user to the registration web page. The link can lead to a web page for a specific event, or to a web page that includes a list of all events, events of a certain type, and/or events in a certain region that are offered by the event provider. An event that is sold out (e.g., the maximum number of registrants are registered) can either state that it is sold out or be dropped from the list.

In step P3, the event provider creates a promotion for the event and selects customers from customer database using promotion system 70. For example, the event provider can create an email that is sent to all recent attendees of a related event, along with customers that have recently registered with the event provider. The email can include a link to a web page that displays additional event details using information system 50. The email can also include a link that allows the customer to be removed from the email list using customer management system 52. In step P4, the customer registers for the event using registration system 62. For a sold out event, registration system 62 can allow a customer to register for a “waiting list,” which will allow the customer on the list to register if a current registrant no longer desires to attend the event. Further, registration system 62 can display a number of openings remaining for an event, or display the number of openings when it is less than a specified amount (e.g., less than 4, less than 20%, etc.). The customer can pay for the event using transaction processing system 40, or a bill can be generated by accounting system 38. In step P5, the event provider holds the event. In step P6, the event provider performs post-event processing. The post-event processing can include obtaining feedback from the event attendees regarding the event details, location, etc. using feedback system 72, analyzing the success of the event using analysis system 74, finalizing the accounting information for the event using accounting system 38, etc.

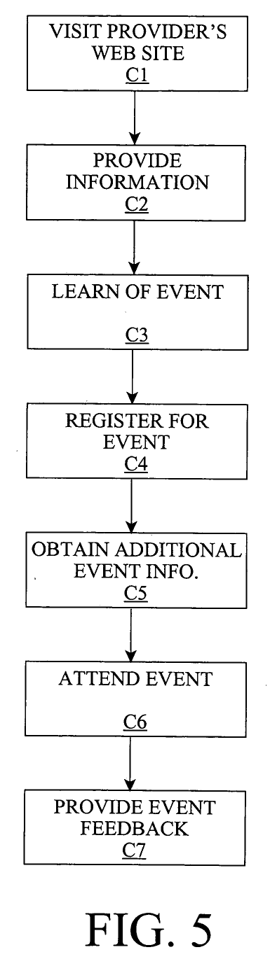

FIG. 5 shows illustrative method steps performed from an event attendee's perspective according to one embodiment of the invention, and is also discussed with reference to FIG. 2. In step C1, a customer visits the event provider's web site. This may be in response to an electronic search for information on the types of events provided by the event provider, marketing done through any media by the event provider, word of mouth, etc. In step C2, the customer provides customer information to the event provider using customer management system 52. For example, the customer may wish to sign up for a free offer, to obtain access to additional information, to sign up for mailings, etc. In step C3, the customer learns of a future event that he/she may like to attend from promotion system 70. In one embodiment, the customer receives an email that promotes the event. The customer can visit the event provider's web site to learn more about the event.

In step C4, the customer registers for the event using registration system 62. As part of the registration, the customer can immediately pay for the event using transaction processing system 40. Alternatively, accounting system 38 can generate a bill for the event that is subsequently sent to the customer. In step C5, the customer, having been properly registered for the event, can obtain additional event information using registrant system 64. Additional event information can include, for example, a more detailed outline for the event, materials related to the event, other registrants for the event, updates on any changes to the event, etc. Further, the customer can be provided with the ability to communicate with the event coordinator and/or other registrants for the event. In step C6, the customer attends the event. In step C7, the customer provides feedback on the event using feedback system 72. In one embodiment, feedback system 72 sends an email to the attendees of the event soliciting their comments on the event. The customer can reply to the email having completed the requested responses. Alternatively, feedback system 72 can fax or mail a questionnaire that the attendees can complete and return via fax or mail. Further, employees of event provider can telephone event attendees, and enter the responses using feedback system 72.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 12 (FIG. 1), and/or user system 26 such that they carry out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A system for integrating event management, the system comprising:
a customer relationship system for managing customer information for customers;
an event management system for managing event information for events; and
a marketing system for contacting customers, the marketing system including:
a promotion system for informing customers of an event; and
a feedback system for obtaining feedback from customers that attended the event.

2. The system of claim 1, further comprising an accounting system for managing accounting information for each event.

3. The system of claim 1, further comprising a transaction processing system for processing electronic payment for an event.

4. The system of claim 1, wherein the marketing system further includes an analysis system for analyzing the event.

5. The system of claim 1, wherein customers are contacted by at least one of: an e-mail, a newsletter, and a telephone call.

6. The system of claim 1, wherein the customer relationship system includes:
an information system for displaying customer information and event information;
a customer management system for allowing a customer to manage the customer information; and
a provider management system for allowing an event provider to manage the customer information.

7. The system of claim 1, wherein the event management system includes:
a configuration system for allowing an event provider to manage the event; and
a registration system for allowing a customer to register for the event.

8. The system of claim 7, wherein the event management system further includes a registrant system for providing data on the event to a customer that has registered for the event.

9. The system of claim 7, wherein the event management system further includes a security system for limiting access to functionality of the event management system.

10. A method of integrating event management over the Internet, the method comprising:
defining an event of an event provider at a third party web site;
adding a link from an event provider web site to an event registration web page at the third party web site;
registering a customer for the event using the event registration web page; and
obtaining feedback on the event from a customer that attended the event.

11. The method of claim 10, further comprising managing accounting information for the event.

12. The method of claim 10, further comprising authorizing payment for the customer over the Internet.

13. The method of claim 10, further comprising providing additional information on the event to the registered customer.

14. The method of claim 10, further comprising limiting access to event information and management functions based on a security level of a user.

15. The method of claim 10, further comprising promoting the event to customers using email.

16. The method of claim 15, further comprising allowing the customer to set a subscription status for receiving event emails.

17. A computer program product comprising a computer useable medium having computer readable program code embodied therein for integrating event management, the program product comprising:
program code configured to manage customer information for event providers;
program code configured to manage event information for the event providers; and
program code configured to market an event of an event provider to customers of the event provider, wherein the program code configured to market an event includes:
program code configured to promote the event to customers using email; and
program code configured to obtain feedback on the event from a customer that attended the event.

18. The computer program product of claim 17, further comprising:
program code configured to manage accounting information for each event; and
program code configured to process payment by a customer for an event.

19. The computer program product of claim 17, wherein the program code configured to manage event information includes:
program code configured to define an event of an event provider at a third party web site;
program code configured to add a link from an event provider web site to an event registration web page at the third party web site;
program code configured to limit access to event information and management functions based on a security level of a user;
program code configured to register a customer for the event using the event registration web page; and
program code configured to provide additional event information to the registered customer.

20. The computer program product of claim 17, wherein the program code configured to manage customer information includes program code configured to allow each customer to manage the customer information for the customer.
